(19) United States
(12) Patent Application Publication
(10) Pub. No.: US 2025/0050774 A1
(43) Pub. Date: Feb. 13, 2025

(54) CHARGING SYSTEM AND VEHICLE

(71) Applicant: TOYOTA JIDOSHA KABUSHIKI KAISHA, Toyota-shi (JP)

(72) Inventor: Shota YONEZAWA, Toyota-shi (JP)

(73) Assignee: TOYOTA JIDOSHA KABUSHIKI KAISHA, Toyota-shi (JP)

(21) Appl. No.: 18/753,533

(22) Filed: Jun. 25, 2024

(30) Foreign Application Priority Data
Aug. 9, 2023 (JP) 2023-129907

(51) Int. Cl. B60L 53/62; B60L 58/19; H02J 7/00

(52) U.S. Cl. CPC B60L 53/62; B60L 58/19; H02J 7/0024; H02J 7/007182

(57) ABSTRACT

The charging system includes a power storage device including a first battery and a second battery, and a control device that performs charging control of the power storage device. The power storage device is configured to execute series charging in a state in which the first battery and the second battery are connected in series, and parallel charging in a state in which the first battery and the second battery are connected in parallel. The control device is configured to switch a charging method from the series charging to the parallel charging after voltage of the power storage device during the series charging reaches a predetermined value, and continue charging the power storage device.

### CROSS-REFERENCE TO RELATED APPLICATION

This application claims priority to Japanese Patent Application No. 2023-129907 filed on Aug. 9, 2023, incorporated herein by reference in its entirety.

### BACKGROUND

### 1. Technical Field

The present disclosure relates to a charging system and a vehicle.

### 2. Description of Related Art

Japanese Patent No. 7006263 discloses a charging system including a power storage device that includes a plurality of batteries and a switching relay, and a control device that controls the switching relay. The switching relay is configured to be capable of switching between a first state in which the batteries are connected in series and a second state in which the batteries are connected in parallel. In this charging system, electric power for charging is supplied from a power supply outside of a vehicle to the power storage device. When a plug-in operation for charging the power storage device is performed, the control device controls the switching relay to the first state. When the maximum charging voltage of the power supply is smaller than a threshold value, the control device transitions the switching relay from the first state to the second state.

### SUMMARY

Now, in the charging of the power storage device in the second state (parallel charging), electric power (charging power) received by the power storage device is smaller than the charging of the power storage device in the first state (series charging). Accordingly, parallel charging tends to take a longer charging time (time taken to complete charging) than series charging. In the charging system described in the above Japanese Patent No. 7006263, the parallel charging is executed when the maximum charging voltage of the power supply is smaller than the threshold value, and accordingly the charging time is conceivably prolonged.

The present disclosure has been made in order to solve the above problem, and an object thereof is to shorten charging time.

A charging system according to an embodiment of the present disclosure includes a power storage device including a first battery and a second battery, and a control device for performing charging control of the power storage device. The power storage device is configured to execute series charging in a state in which the first battery and the second battery are connected in series, and parallel charging in a state in which the first battery and the second battery are connected in parallel. The control device is configured to switch a charging method from the series charging to the parallel charging after voltage of the power storage device during the series charging reaches a predetermined value, and continue charging the power storage device.

According to another aspect of the present disclosure, there is provided a vehicle including the above charging system.

According to the present disclosure, the charging time can be shortened.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a charging system according to an embodiment of the present disclosure;

FIG. 2 is a flowchart illustrating a charging method according to an embodiment of the present disclosure;

FIG. 3 is a diagram showing a state transition of a power storage device charged by the charging method according to each of the embodiment and the modification in comparison;

FIG. 4 is a diagram illustrating charging data measured with respect to a charging method according to each of the embodiments and the modifications;

FIG. 5 is a flow chart showing a variation of the charge process shown in FIG. 2; and

FIG. 6 is a diagram showing a modification of the charging system shown in FIG. 1.

### DETAILED DESCRIPTION OF EMBODIMENTS

An embodiment of the present disclosure will be described in detail with reference to the drawings. The same or corresponding parts in the drawings are designated by the same reference signs and repetitive description will be omitted.

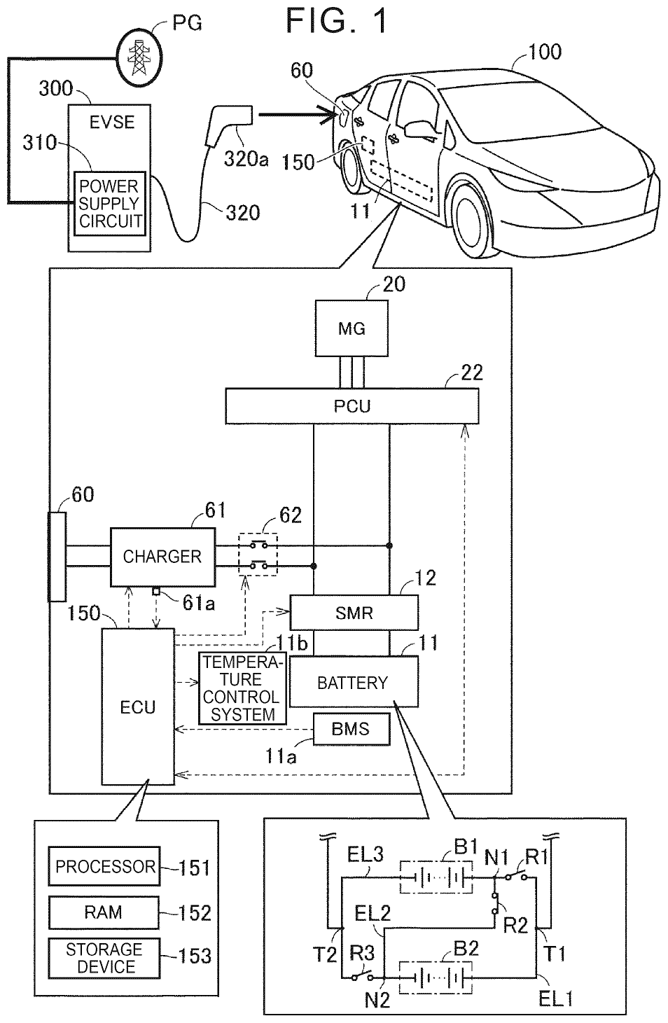

FIG. 1 is a diagram illustrating a charging system according to an embodiment of the present disclosure. Referring to FIG. 1, a charging system according to this embodiment includes a vehicle 100 and a EVSE 300. EVSE 300 is supplied with power from a power system PG. EVSE means Electric Vehicle Supply Equipment. The power system PG is a power grid constructed by a transmission and distribution facility. A plurality of power plants (not shown) is connected to the power system PG. Electric power system PG are supplied with electric power from their power plants. In this embodiment, the power system PG provides AC power.

EVSE 300 includes a power supply circuit 310 and a charge cable 320. The power supply circuit 310 is electrically connected to the power system PG. The charge cable 320 has a connector 320a at its distal end and includes a communication line and a power line therein. One electric wire may also serve both as a communication line and a power line. The power supply circuit 310 converts the electric power supplied from the power system PG into electric power suitable for power supply to the vehicle 100, and outputs the converted electric power to the charge cable 320. EVSE 300 outputs AC power from the connector 320a.

The vehicle 100 includes an inlet 60 to which the connector 320a can be attached and detached. When the connector 320a of the charge cable 320 connected to the main body of EVSE 300 is connected to the inlet 60 of the vehicle 100 in the parked state, the vehicle 100 is electrically connected to the power system PG via EVSE 300 (hereinafter, also referred to as a “plug-in state”). On the other hand, for example, while the vehicle 100 is traveling, the vehicle 100 is not electrically connected to each of EVSE 300 and the power system PG (hereinafter, also referred to as a “plug-out state”).

The vehicle 100 further includes a battery 11, a System Main Relay (SMR) 12, a Motor Generator (MG) 20, a Power Control Unit (PCU) 22, and an Electronic Control Unit (ECU) 150. ECU 150 includes a processor 151, a Random Access Memory (RAM) 152, and a storage device 153. The storage device 153 is configured to store stored information. In addition to the program, the storage device 153 stores information (for example, a map, a mathematical expression, and various parameters) used in the program. In this embodiment, the processor 151 executes a program stored in the storage device 153 to perform various kinds of control by ECU 150 (for example, charging control of the battery 11). However, these processes may be executed only by hardware (electronic circuit) without using software. In ECU 150 of this embodiment, the battery 11 corresponds to an exemplary “control device” and an exemplary “power storage device” according to the present disclosure.

The vehicle 100 is configured to be able to travel using electric power stored in the battery 11. The vehicle 100 is, for example, battery electric vehicle (BEV) without engines (internal combustion engines). However, the present disclosure is not limited thereto, and the vehicle 100 may be plug-in hybrid electric vehicle (PHEV) including an internal combustion engine, or may be another electrified vehicle (xEV).

The battery 11 includes a battery B1 (first battery), a battery B2 (second battery), and three relay R1, R2, R3. In this embodiment, each of the batteries B1, B2 is a battery pack. The assembled battery is configured by electrically connecting a plurality of secondary batteries (commonly referred to as “cells”) to each other. The plurality of cells in the assembled battery are connected in series, for example. However, the connection mode of the cells in the assembled battery is not limited to series, and may include parallel connection. Each of the batteries B1, B2 may be a single secondary battery instead of a battery pack.

The relay R1 is provided in an electric wire EL1 connecting the positive electrode of the battery B1 and the positive electrode of the battery B2. The relay R2 is provided in an electric wire EL2 connecting the positive electrode of the battery B1 and the negative electrode of the battery B2. The relay R3 is provided in an electric wire EL3 connecting the negative electrode of the battery B1 and the negative electrode of the battery B2. The electric wire EL1 and the electric wire EL2 are connected to each other at a node N1. The electric wire EL2 and the electric wire EL3 are connected to each other at a node N2. The positive electrode terminal T1 and the negative electrode terminal T2 of the battery 11 are respectively provided on the electric wire EL1, EL3. The relay R1 is located between the positive electrode terminal T1 and the node N1. The relay R3 is located between the negative electrode terminal T2 and the node N2. When the relays R1, R2, R3 are OFF, ON, OFF, the batteries B1 and B2 are connected in series. When the relays R1, R2, R3 are ON, OFF, ON, the batteries B1 and B2 are connected in parallel. As a switching relay (relay R1, R2, R3) for switching between a series state and a parallel state, an electromagnetic-type mechanical relay can be adopted. Alternatively, however, a semiconductor relay such as a thyristor, a triac, or a transistor may be employed as the switching relay.

The battery 11 is provided with a Battery Management System (BMS) 11a for monitoring the condition of the battery 11 and a temperature control system 11b for controlling the temperature of the battery 11. BMS 11a includes various sensors for detecting the status (e.g., voltage, current, and temperature) of the battery 11, and a monitoring IC (integrated circuit) to which detection signals from the various sensors are inputted. The temperature control system 11b includes at least one of a heater and a cooler. The cooling system may be water-cooled or oil-cooled. The temperature control system 11b is controlled by ECU 150.

In this embodiment, a voltage sensor and a temperature sensor are provided for each cell constituting the battery 11 (assembled battery). However, the present disclosure is not limited thereto, and each of the voltage sensor and the temperature sensor may be provided one for each of a plurality of cells, or may be provided only one for one battery pack. The monitoring IC generates a signal (hereinafter, also referred to as a “BMS signal”) indicating the status of the battery 11 by using the detection signals from the various sensors, and outputs the generated BMS signal to ECU 150. ECU 150 acquires, for example, the temperature, current, voltage, and State Of Charge (SOC) of the battery 11 based on BMS signal. SOC indicates the remaining amount of stored electricity, and represents, for example, the ratio of the present amount of stored electricity to the amount of stored electricity in a fully charged state in the range of 0 to 100%. The monitoring IC may have a cell-voltage equalization function.

The vehicle 100 further includes a charger 61 and a charging relay 62. The charger 61 and the charging relay 62 are located between the inlet 60 and the battery 11. Each of the charger 61 and the charging relays 62 is controlled by an ECU 150. In this embodiment, a charging line including an inlet 60, a charger 61, and a charging relay 62 is connected between SMR 12 and PCU 22. However, the present disclosure is not limited thereto, and a charge line may be connected between the battery 11 and SMR 12.

The charger 61 charges the battery 11 using the electric power input from the outside of the vehicle to the inlet 60. The charger 61 includes a power conversion circuit (for example, an inverter) and is configured to be capable of adjusting a charging current. The power conversion circuitry performs DC(DC)/AC(AC) conversion. The charging relay 62 switches connection/disconnection of an electric path from the inlet 60 to the battery 11. Vehicle 100 further includes a detector 61a that monitors the condition of charger 61. The detector 61a includes various sensors (e.g., a current sensor and a voltage sensor) for detecting the status of the charger 61, and outputs the detected data to ECU 150.

In the vehicle 100 in the plug-in state, external charging (that is, charging of the battery 11 by electric power from the outside of the vehicle) is enabled. Power for external charging is supplied from the power system PG to the inlet 60 through the charge cable 320 of EVSE 300, for example. The charger 61 converts AC power received by the inlet 60 into DC power suitable for charging the battery 11, and outputs the DC power to the battery 11. When the external charging is performed, the charging relay 62 is brought into a closed state (connected state), and when the external charging is not performed, the charging relay 62 is brought into an open state (shut-off state).

MG 20 is, for example, a three-phase AC motor generator. MG 20 functions as a driving motor of the vehicle 100. MG 20 is driven by PCU 22 to rotate the drive wheels of the vehicle 100. Further, MG 20 performs regenerative power generation and outputs the generated electric power to the battery 11. The number of driving motors included in the vehicle 100 is arbitrary.

PCU 22 includes circuitry for driving MG 20 using power supplied from the battery 11. SMR 12 switches the connection/disconnection of the electric path from the battery 11 to PCU 22. PCU 22 includes inverters and converters, for example. Each of SMR 12 and PCU 22 is controlled by an ECU 150. SMR 12 is brought into a closed state (connected state) when the vehicle 100 is traveling. SMR 12 is also closed when power is exchanged between the battery 11 and the inlet 60 (and thus the outside of the vehicle).

As described above, the battery 11 includes a series/parallel connection switching mechanism. The battery 11 is configured to be capable of performing charging (series charging) of the battery 11 in the series state and charging (parallel charging) of the battery 11 in the parallel state. However, in the parallel charging, the electric power (charging power) received by the battery 11 (power storage device) is smaller than in the series charging. When charging (parallel charging) is performed in a state where the batteries B1 and B2 are connected in parallel, the current and voltage of the battery B1 and the current and voltage of the battery B2 are each one-half as compared with a case where charging (series charging) is performed in a state where the batteries B1 and B2 are connected in series. Then, the total power received by the batteries B1 and B2 connected in parallel in the parallel charging is one-half of the total power received by the batteries B1 and B2 connected in series in the series charging. Accordingly, parallel charging tends to take a longer charging time (time taken to complete charging) than series charging.

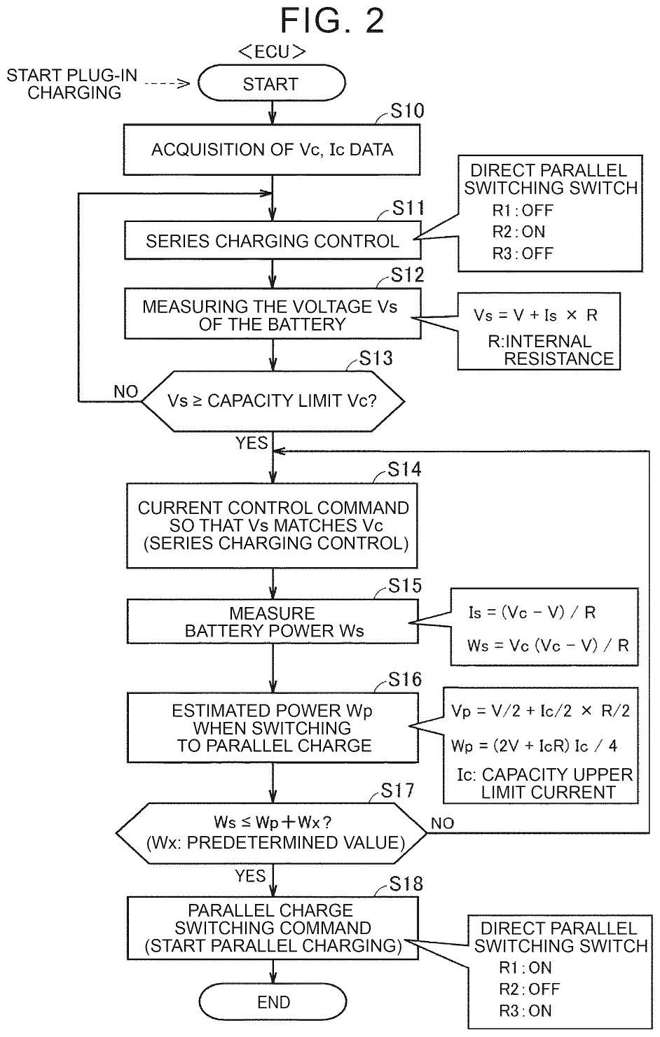

Therefore, ECU 150 according to this embodiment executes a series of processes shown in FIG. 2 described below, whereby after the voltage of the battery 11 during series charging reaches a predetermined value, the charging method is switched from the series charging to the parallel charging, and the charging of the battery 11 is continued.

FIG. 2 is a flow chart illustrating a charging method according to this embodiment. “S” in the flowchart means step. The process illustrated in this flow chart is executed by ECU 150 in the vehicle 100 in the plug-in status. The process shown in FIG. 2 is started when a predetermined charge-start condition is satisfied with respect to the vehicle 100. For example, the charging start condition may be satisfied when the vehicle 100 is in the plug-in state. Alternatively, the charging start condition may be satisfied when the vehicle 100 is in the plug-in state and the user performs a charging start operation on EVSE 300 or the vehicle 100.

Referring to FIG. 2 together with FIG. 1, in S10, ECU 150 acquires facility information related to EVSE 300 from a EVSE 300 (a power supply facility that supplies electric power to the battery 11) connected to the vehicle 100. The facility information includes a facility upper limit voltage indicating the maximum charging voltage of EVSE 300 (hereinafter, referred to as “Vc”) and a facility upper limit current indicating the maximum charging current of EVSE 300 (hereinafter, referred to as “Ic”). When the charge voltage or the charge current of the battery 11 exceeds Vc or Ic, EVSE 300 cannot charge the battery 11.

In a subsequent S11, ECU 150 sets the battery 11 in series by turning OFF, ON, OFF the relays R1, R2, R3, and transmits a charging command for series-charging to the charger 61. The charger 61 that has received the charging command controls the charging current of the battery 11 so as to bring the charging current of the battery 11 close to the target charging current value indicated by the charging command. As a result, the battery 11 is externally charged. ECU 150 determines a target charging current value equal to or less than Ic, raises the charging current of the battery 11 to the target charging current value, and then executes constant current charging at the target charging current value. In this embodiment, Ic is the target charge current.

As described above, when the predetermined charge start condition is satisfied while EVSE 300 (power supply facility outside the vehicle) and the vehicle 100 are electrically connected to each other, ECU 150 starts series-charging of the battery 11 using the electric power supplied from EVSE 300 (S11). However, when the predetermined charge termination condition is satisfied in S11, the process shown in FIG. 2 ends. The charging end condition is satisfied, for example, when the storage amount of the battery 11 has reached the target value. The target may be automatically set by ECU 150 or EVSE 300, or may be set by the user. The condition of the battery 11 (e.g., voltage and SOC) is measured by BMS 11a. Further, for example, the charging end condition may be satisfied in response to an instruction to stop charging from the user. When the charge termination condition is satisfied during the series-charging, the process flow shown in FIG. 2 ends without executing the switching to the parallel charging (S18).

In the following S12, ECU 150 measures the voltage of the battery 11 during series-charging (hereinafter referred to as “Vs”). Specifically, ECU 150 calculates Vs using the no-load voltage, the charge current, and the inner resistance of each of the batteries B1 and B2. The no-load voltage is also commonly referred to as “OCV”. ECU 150 may use a map previously stored in the storage device 153 to determine the inner resistivity of the batteries B1, B2 from SOC and temperature of the batteries B1, B2 measured by BMS 11a, respectively. ECU 150 may calculate the no-load voltage, the charging current, and the internal resistance of the battery 11 from the no-load voltage, the charging current, and the internal resistance of each of the batteries B1 and B2. The charging current of the battery 11 obtained here corresponds to a current (hereinafter, referred to as “Is”) of the battery 11 during series-charging. ECU 150 may calculate Vs according to the equation “Vs=no-load voltage+Is×internal resistance” for the battery 11. According to such a method, it is easy to calculate the voltage of the battery 11 during series charging with high accuracy.

In the following S13, ECU 150 determines whether Vs is greater than or equal to Vc. If Vs is less than Vc (NO at S13), the process returns to S11 and the series-charge is continued. Series-charging (S11) increases Vs of the battery 11. Then, when Vs reaches Vc (YES in S13), the process proceeds to S14.

In S14, ECU 150 transmits a current suppression command for lowering the charging current of the battery 11 to the charger 61. The current suppression command indicates a target charge current that matches Vs of the battery 11 to Vc. The charger 61 that has received the current suppression command controls the charging current of the battery 11 so that the voltage (Vs) of the battery 11 is maintained at Vc while the charging current of the battery 11 is lowered. Thus, the series charging is continued. However, the control method of series charging is switched from constant current charging to constant voltage charging.

In S15, ECU 150 measures the charging power (hereinafter, referred to as “Ws”) of the battery 11 during series-charging. ECU 150 determines Ws based on the status of the battery 11 measured by BMS 11a. ECU 150 may calculate Ws according to the equation “Ws=Vc×(Vc−no-load voltage)/internal resistance” for EVSE 300 and battery 11.

Subsequently, ECU 150 predicts the charging power (hereinafter, referred to as “Wp”) of the battery 11 when the charging method is switched from the series charging to the parallel charging in S16. ECU 150 uses, for example, a Ic to determine Wp. ECU 150 may calculate Wp according to the equation “Wp=(2×no-load voltage+Ic×internal resistance)×Ic/4” for EVSE 300 and battery 11. Wp corresponds to an exemplary “parallel charge power” according to the present disclosure.

Subsequently, ECU 150 determines, in S17, whether Ws has fallen below a reference value determined based on Wp. In this embodiment, a value (=Wp+Wx) obtained by adding a predetermined margin (hereinafter, referred to as “Wx”) to Wp is set as the reference value. Wx can be set arbitrarily. Wx may be a power value greater than 0 or may be 0.

If Ws is greater than the above reference (NO in S17), the process returns to S14 and the series-charge is continued. The electric power (Ws) of the battery 11 is lowered by the current suppressing command (S14). Then, when Ws reaches the above reference value (YES in S17), the process proceeds to S18.

In S18, ECU 150 switches the charging method from series-charging to parallel-charging and continues charging the battery 11. Specifically, ECU 150 sets the battery 11 in parallel by turning ON, OFF, ON the relays R1, R2, R3, and transmits a charging command for parallel charging to the charger 61. The charger 61 that has received the charging command controls the charging current of the battery 11 so as to bring the charging current of the battery 11 close to the target charging current value indicated by the charging command. As a result, parallel charging of the battery 11 is performed. ECU 150 determines a target charging current value equal to or less than Ic/2, lowers the charging current of the battery 11 to the target charging current value, and then executes constant current charging at the target charging current value. In this embodiment, the value obtained by dividing Ic/2 (Ic by 2) is set as the target charge current value. The parallel charging started in S18 may be continued until a predetermined charging termination condition is satisfied.

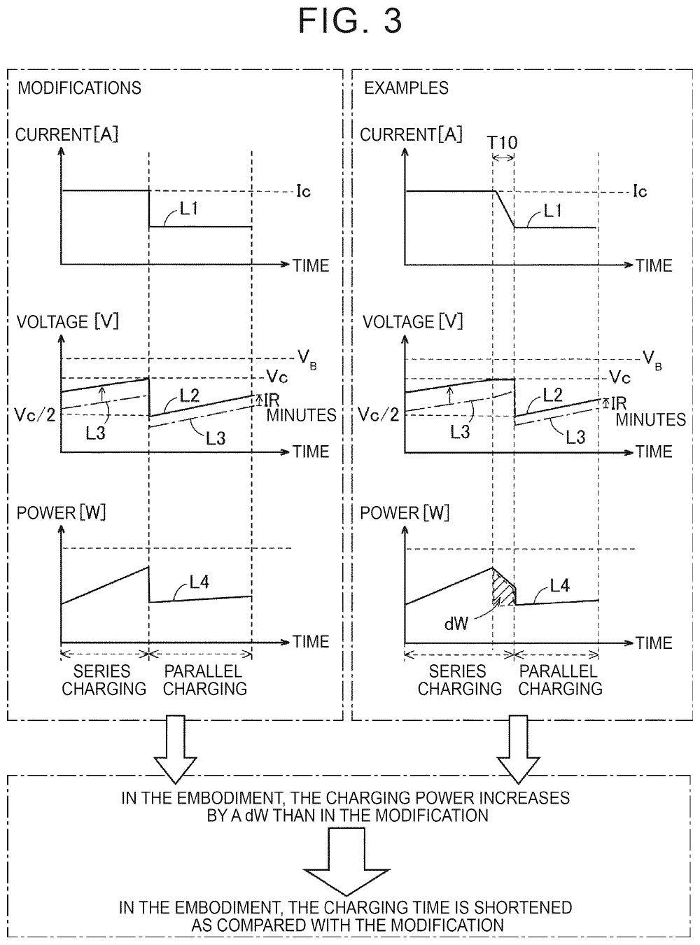

FIG. 3 is a diagram showing the state-transition of the battery 11 charged by the charging methods according to the embodiment and the modification. The charging method according to the embodiment corresponds to the charging method described above shown in FIG. 2. The charging method according to the modification is a method of switching the charging method from the series charging to the parallel charging at a timing when the voltage of the battery 11 during the series charging reaches a predetermined value (for example, Vc). In either method, after the voltage of the battery 11 during the series charging reaches a predetermined value (for example, Vc), the charging method is switched from the series charging to the parallel charging.

In FIG. 3, the line L1, L2, L3, L4 indicates the charging current, the load voltage, the no-load voltage, and the charging power of the battery 11, respectively. In FIG. 3, “VB” indicates the voltage (battery upper limit voltage) of the battery 11 when the battery 11 is fully charged in series by the series charging control (S11) without the current suppression (S14). If Vc is higher than VB, the series-charging (quick charging) can be continued until the charging is completed. The period T10 indicates a period from when the voltage of the battery 11 during the series-charging reaches a predetermined value (for example, Vc) until when the charging method of the battery 11 is switched to the parallel charging. The period T10 corresponds to an exemplary “switching determination period” according to the present disclosure. In the period T10, the charging power of the charging method according to the embodiment is higher than that of the charging method according to the modification. Therefore, the amount of charge power in the charging method according to the embodiment is larger than the amount of charge power in the charging method according to the modification by the amount of power dW shown in FIG. 3.

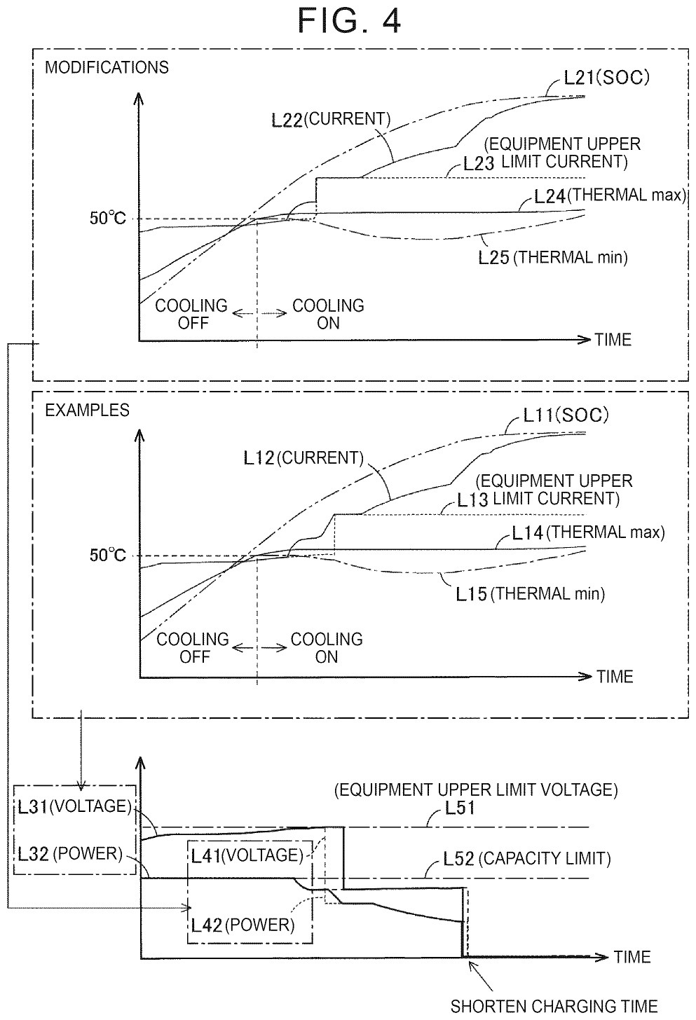

FIG. 4 is a diagram illustrating a charging method according to an embodiment of the present disclosure. In FIG. 4, each of the lines L11, L12, L14, L15, L31, L32 indicates SOC, the charging current, the maximum cell temperature, the minimum cell temperature, the voltage, and the power of the battery 11 in the charging process according to the embodiment. Each of the lines L21, L22, L24, L25, L41, L42 indicates SOC, the charging current, the maximum cell temperature, the minimum cell temperature, the voltage, and the power of the battery 11 in the charging process according to the modification. Each of the lines L13, L23 indicates a maximum charge current (an upper limit current) of a power supply facility that supplies electric power to the battery 11. The line L51, L52 indicates the maximum charging voltage (the upper limit voltage of the facility) and the maximum charging power (the upper limit power of the facility) of the power supply facility.

In the embodiment shown in FIG. 4, SOC of the battery 11 was charged from about 15% to about 80%. When the maximum cell temperature (the temperature of the cell having the highest temperature in the battery 11) becomes 50° C. or higher during the charge of the battery 11, the temperature control system 11b cools the battery 11 using the electric power supplied from the power supply facility (for example, EVSE 300). From the obtained data, it was confirmed that the charging method according to the embodiment has a shorter charging time than the charging method according to the modification. In one example, the charge period until SOC of the battery 11 reaches from 15% to 78% is 0.3 minutes shorter in the charging method according to the example.

As described above, the charge process according to this embodiment includes the processes shown in FIG. 2. Then, in the charging system according to this embodiment, ECU 150 (control device) is configured to switch the charging method from the series charging to the parallel charging and continue the charging of the battery 11 after the voltage of the battery 11 during the series charging reaches a predetermined value.

According to the series charging, the battery 11 can be charged with a charging power larger than that of the parallel charging. The higher the charging power, the higher the charging speed. However, as the charging of the battery 11 progresses, the amount of electricity stored in the battery 11 increases, and the no-load voltage of the battery 11 increases. The voltage of the battery 11 during series-charging is obtained by adding a voltage increase (IR) due to the charging current to the no-load voltage. If the voltage of the battery 11 during series charging becomes too high, the charging may not be continued depending on the specifications of the equipment that supplies electric power to the battery 11. On the other hand, while the voltage of the battery 11 during the series charging is low, the charging speed of the battery 11 can be increased by continuing the series charging. Therefore, in the charging system, the series charging of the battery 11 is continued while the voltage of the battery 11 during the series charging does not reach a predetermined value. As a result, the charging time (time taken to complete charging) can be shortened. Then, after the voltage of the battery 11 during the series charging reaches a predetermined value, the charging method switches from the series charging to the parallel charging. The voltage of the battery 11 decreases by switching the charging method from series charging to parallel charging. Accordingly, it is possible to prevent the voltage of the battery 11 from becoming excessively high during charging of the battery 11.

With the recent standardization evolution, the voltage of the in-vehicle battery and the power supply equipment is becoming higher. However, at present, low-voltage power supply equipment remains. In this regard, according to the charging system described above, by switching the battery 11 which becomes high voltage in series connection to the parallel connection during charging, the battery 11 can be charged not only by the high voltage equipment but also by the low voltage equipment (old-type or household power supply equipment).

In the above-described embodiment, ECU 150 lowers the charging current of the battery 11 during the series charging in the switching determination period (for example, the period T10 shown in FIG. 3) from when the voltage of the battery 11 during the series charging reaches a predetermined value until when the charging method of the battery 11 is switched to the parallel charging. By reducing the current of the battery 11 during series charging in this way, the voltage increase due to the charging current is suppressed. In the charging system according to the above-described embodiment, the voltage of the battery 11 is suppressed from becoming excessively high during series charging of the battery 11 by the current control. Therefore, the period (switching determination period) during which the series charging of the battery 11 is continued is easily lengthened.

In the charging method according to the embodiment, after the voltage of the battery 11 during the series charging becomes equal to or higher than the predetermined value, the charging method of the battery 11 is switched from the series charging to the parallel charging at a timing when the charging power of the battery 11 during the series charging becomes equal to or lower than the reference value determined based on Wp (parallel charging power). According to such methods, the charge-time shortening effect is increased (see FIG. 3 and FIG. 4). Specifically, in the period T10 (FIG. 3), the series charging of the battery 11 is executed, and the current of the battery 11 decreases during the series charging. As the charging current decreases, the charging power decreases. If the series charging of the battery 11 is continued even if the charging power of the battery 11 is reduced, a larger charging power can be obtained by switching to the parallel charging rather than continuing the series charging. If the series charging of the battery 11 is continued until such a situation occurs, the charging time of the battery 11 becomes longer. Therefore, in the charging system according to this embodiment, ECU 150 predicts the charging power (Wp) when the charging method is switched to the parallel charging, and switches the charging method to the parallel charging according to the predicted charging power. This makes it possible to switch the charging method to the parallel charging at an appropriate timing.

In the above-described embodiment, Vc is adopted as the predetermined value (voltage value for switching the charging method). Then, ECU 150 controls the current of the battery 11 so that the voltage of the battery 11 matches the upper limit voltage (Vc) of T10 (in FIG. 3). In the period T10 (switching determination period), the charging power decreases with a decrease in the charging current, but by keeping the voltage of the battery 11 high, a decrease in the charging power of the battery 11 is suppressed. However, the predetermined value can be changed as appropriate. A voltage value lower than Vc by a predetermined margin may be adopted as the predetermined value.

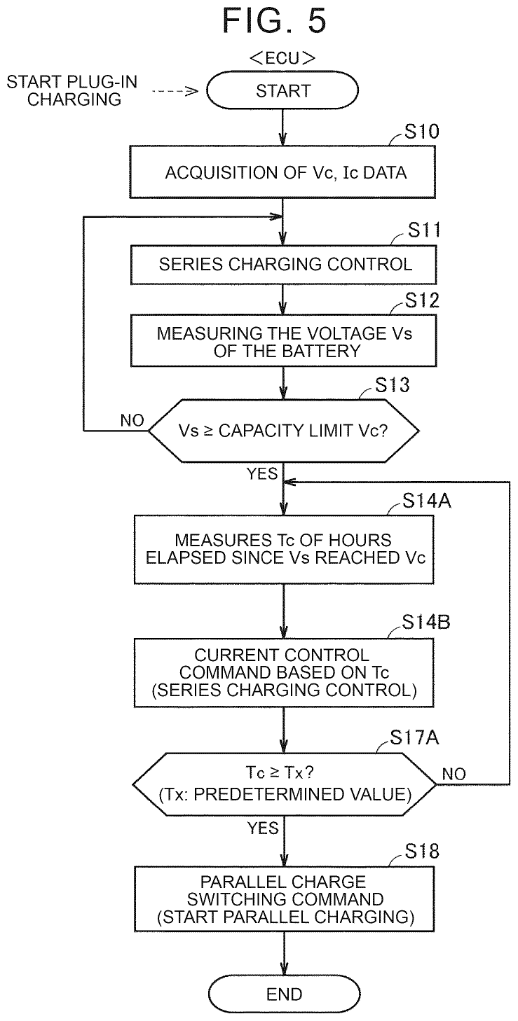

ECU 150 may execute the processing flow shown in FIG. 5 instead of the processing flow shown in of FIG. 2. FIG. 5 is a flow chart illustrating a variation of the charge methodology shown in FIG. 2. The process flow shown in FIG. 5, except that S14 to S17 (FIG. 2) S14A, S14B, S17A has been adopted instead, is the same as the process flow shown in FIG. 2. S14A, S14B and S17A will be described below.

Referring to FIG. 5, in this modification, the elapsed time (hereinafter referred to as “S11”) after Vs reaches Vc when Vs reaches Vc (YES in S13) during the series-charging of the battery 11 by Tc process is measured by ECU 150 in S14A. Subsequently, ECU 150 transmits, in S14B, a current suppressing command for reducing the charging current of the battery 11 to the charger 61. In this variation, ECU 150 determines the current aperture (slope of the current versus time) based on Tc. ECU 150 may increase the current aperture as Tc increases. The charger 61 that has received the current suppression command controls the charging current of the battery 11 so that the charging current of the battery 11 decreases in accordance with the current reduction amount indicated by the current suppression command. Note that the current aperture amount in the switching determination period may be a fixed value.

Subsequently, ECU 150 determines, in S17A, whether or not Tc has become equal to or longer than a predetermined period (hereinafter, referred to as “Tx”). Tx may be fixed or may be variable depending on Vc and/or Ic. When Tc reaches Tx (YES at S17A), the process proceeds to S18 (switching to parallel charge).

Prior to starting the external charging of the battery 11, ECU 150 (control device) may select one charging control from the options including the charging control shown in FIG. 2 and the charging control shown in FIG. 5, and execute the selected charging control. ECU 150 may determine which charging control to perform based on the facility information (Vc and/or Ic).

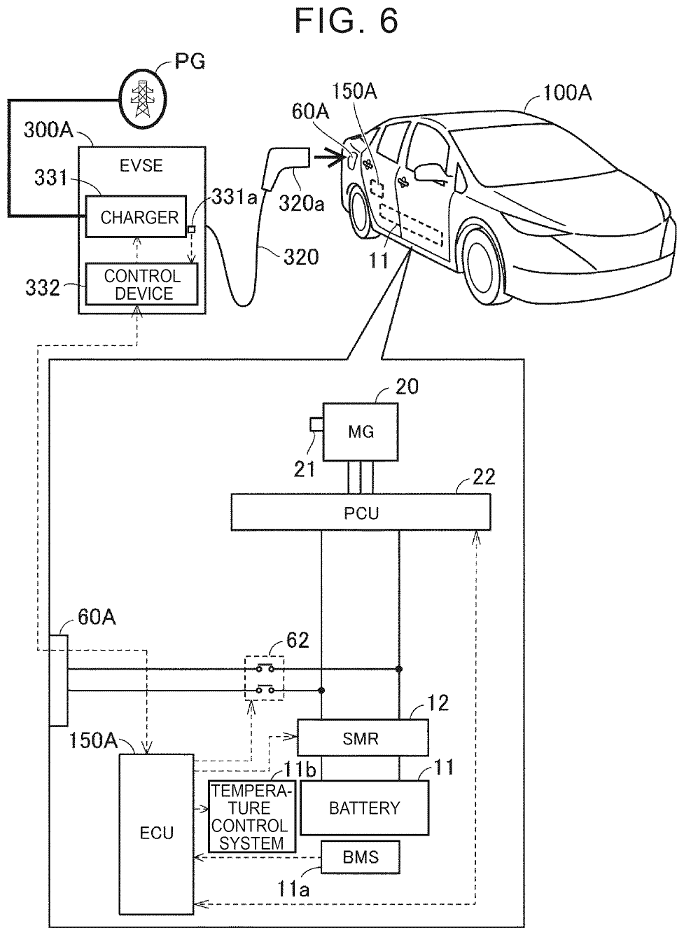

In the embodiment and the modification described above, the charging control of the battery 11 is performed using the charger 61 mounted on the vehicle 100. However, the present disclosure is not limited to this, and the charging control of the battery 11 may be performed using a charger mounted on EVSE. FIG. 6 is a diagram illustrating a modification of the charging system shown in FIG. 1.

Referring to FIG. 6, EVSE 300A incorporates a charger 331, a detector 331a, and a control device 332. The charger 331 includes a power conversion circuit (for example, an inverter) and is configured to adjust a charging current. The detector 331a includes various sensors (e.g., a current sensor and a voltage sensor) for detecting the status of the charger 331, and outputs the detected data to the control device 332. The connector 320a of EVSE 300A is connected to the inlet 60A of the vehicle 100A, so that the vehicle 100A is in a plug-in condition. In the vehicle 100A in the plug-in status, ECU 150A performs external charging of the battery 11 while communicating with the control device 332 via the charge cable 320. During external charging, the charger 331 converts AC power supplied from the power system PG into DC power, and outputs the DC power to the connector 320a. That is, EVSE 300A outputs DC power. The DC power outputted from EVSE 300A to the vehicle 100A is inputted to the inlet 60A and is charged in the battery 11.

ECU 150A performs external charging of the battery 11 by the charging methods shown in FIG. 2 or FIG. 5. ECU 150A transmits a charge command and a current suppression command to the control device 332. The control device 332 controls the charger 331 in accordance with a command received from ECU 150A. As a result, the battery 11 is externally charged. The control device 332 may acquire the charge current by using the current sensor of the detector 331a.

The processes shown in FIG. 2 and FIG. 5 can be changed as appropriate. For example, the order of processing may be changed, or unnecessary steps may be omitted, depending on the purpose. Further, the content of any of the processes may be changed. For example, the operations from S14 to S16 of FIG. 2 may be performed in parallel and concurrently.

The configuration of the vehicle is not limited to the above-described configuration (see FIG. 1). For example, the vehicle may be configured to be capable of contactless charging. The vehicle performing the non-contact charging may be regarded as being in a state corresponding to the “plug-in state” described above when the positioning of the power transmission unit (e.g., the power transmission coil) on the power supply facility side and the power reception unit (e.g., the power reception coil) on the vehicle side is completed.

The power storage device may be mounted on a resource other than the automobile. The resource may be a mobile body other than an automobile (a railway vehicle, a ship, an airplane, a drone, a walking robot, a robot cleaner, or the like). The resource may be an electromechanical appliance (a lighting device, an air-conditioning facility, a cooking appliance, a television, a refrigerator, a washing machine, or the like). The power storage device to be charged may be a stationary power storage device used in a building (a house, a factory, or the like) or outdoors.

The embodiment disclosed herein should be considered as illustrative and not restrictive in all respects. The scope of the present disclosure is shown by the claims, rather than the above embodiments, and is intended to include all modifications within the meaning and the scope equivalent to those of the claims.

What is claimed is:

1. A charging system comprising:
a power storage device including a first battery and a second battery; and
a control device for performing charging control of the power storage device, wherein:
the power storage device is configured to execute series charging in a state in which the first battery and the second battery are connected in series, and parallel charging in a state in which the first battery and the second battery are connected in parallel; and
the control device is configured to switch a charging method from the series charging to the parallel charging after voltage of the power storage device during the series charging reaches a predetermined value, and continue charging the power storage device.

2. The charging system according to claim 1, wherein the control device reduces charging current of the power storage device during the series charging, in a switching determination period from when the voltage of the power storage device during the series charging reaches the predetermined value, until the charging method of the power storage device is switched to the parallel charging.

3. The charging system according to claim 2, wherein:
the control device is configured to calculate the voltage of the power storage device during the series charging using no-load voltage, charging current, and internal resistance, of each of the first battery and the second battery;
the predetermined value is a facility upper limit voltage indicating a maximum charging voltage of a facility for supplying electric power to the power storage device; and
the control device controls the charging current of the power storage device in the switching determination period, such that the voltage of the power storage device during the series charging matches the predetermined value.

4. The charging system according to claim 3, wherein:
the control device predicts parallel charging power that is charging power of the power storage device when the charging method is switched to the parallel charging during the series charging of the power storage device; and
the control device is configured to switch the charging method of the power storage device from the series charging to the parallel charging at a timing when the charging power of the power storage device during the series charging becomes no higher than a reference value decided based on the parallel charging power, after the voltage of the power storage device during the series charging becomes no lower than the predetermined value.

5. A vehicle comprising the charging system according to claim 1, wherein, when a predetermined condition is satisfied in a state in which a power supply facility outside of the vehicle and the vehicle are electrically connected to each other, the control device starts the series charging of the power storage device using electric power supplied from the power supply facility.
